(19) United States
(12) Patent Application Publication
(10) Pub. No.: US 2024/0356954 A1
(43) Pub. Date: Oct. 24, 2024

(54) AUTOMATED EVALUATION OF CYBERSECURITY TOOLS

(71) Applicant: INTERNATIONAL BUSINESS MACHINES CORPORATION, ARMONK, NY (US)

(72) Inventors: Mahbod Tavallee, Arlington, MA (US); Rishabh Singh, Bangalore (IN); Stepan Vovshchuk, Wroclaw (PL)

(21) Appl. No.: 18/302,423

(22) Filed: Apr. 18, 2023

(51) Int. Cl. H04L 9/40; G06F 21/55

(52) U.S. Cl. CPC H04L 63/1433; G06F 21/552; H04L 63/0263; G06F 2201/81

(57) ABSTRACT

Described are techniques for characterizing performance of a cybersecurity detection tool. The techniques include generating a cybersecurity result set in response to applying synthetic test data to the cybersecurity detection tool. The techniques further include extracting respective rules from the cybersecurity detection tool. The techniques further include characterizing the performance of the cybersecurity detection tool based on the cybersecurity result set and the respective rules.

### BACKGROUND

The present disclosure relates to cybersecurity, and, more specifically, to automated performance evaluation of cybersecurity tools.

As cybersecurity attacks grow in number, they also increase in complexity and become more difficult to detect. Threat actors have learned to bypass traditional security solutions, and Security Operation Centers (SOCs) have invested heavily on more advanced detection techniques such as the Security Information and Event Management (SIEM) and Endpoint Detection and Response (EDR) systems. These systems can provide the flexibility to enhance detection techniques as new threat techniques and actors are discovered.

Even though the SIEM and EDR solutions provide more effective detection techniques to identify cybersecurity attacks, they introduce new complexity that is not completely addressed by the security vendors. Some of these issues include: (i) implementation of effective rules that are complex and require deep knowledge of security and programming; (ii) prioritization and selection of the SIEM or EDR rules as they can be resource-intensive and only a limited number of rules can run on the system; and (iii) management of hundreds of rules to effectively deprecate rules that are non-performant and replace them with more advanced rules that can provide better detection coverage.

### SUMMARY

Aspects of the present disclosure are directed toward a computer-implemented method for characterizing performance of a cybersecurity detection tool. The method includes generating a cybersecurity result set in response to applying synthetic test data to the cybersecurity detection tool. The method further includes extracting respective rules from the cybersecurity detection tool. The method further includes characterizing the performance of the cybersecurity detection tool based on the cybersecurity result set and the respective rules.

Advantageously, the aforementioned method provides an accurate and comprehensive characterization of the cybersecurity tool, thereby enabling enterprises to evaluate many cybersecurity tools and select one or many cybersecurity tools with acceptable performance metrics for a given environment.

In additional aspects of the present disclosure including the aforementioned method, the characterizing the performance of the cybersecurity detection tool further includes presenting, on a user interface, an overall average score, a MITRE® Tactics, Techniques, and Procedures (TTP) coverage score, a rule coverage score, a true positive rate score, a false positive rate score, a role status score, a rule performance score, a duplicate rules score, and a rule changes score.

Advantageously, the aforementioned aspects of the present disclosure provide an overall score encompassing numerous underlying scores together with the numerous underlying scores, thereby providing ease of usability and comprehensive information related to the performance of the cybersecurity tool.

Additional aspects of the present disclosure are directed to systems and computer program products configured to perform the method described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example computational environment implementing a cybersecurity tool evaluator, in accordance with some embodiments of the present disclosure.

FIG. 2 illustrates a block diagram of an example cybersecurity assessment, in accordance with some embodiments of the present disclosure.

FIG. 3 illustrates a diagram of an example output of the cybersecurity tool evaluator, in accordance with some embodiments of the present disclosure.

FIG. 4 illustrates a flowchart of an example method for automated assessment of cybersecurity tools, in accordance with some embodiments of the present disclosure.

FIG. 5 illustrates a flowchart of an example method for characterizing the performance of a cybersecurity detection tool, in accordance with some embodiments of the present disclosure.

FIG. 6 illustrates a block diagram of an example computing environment, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward cybersecurity, and, more specifically, to automated performance evaluation of cybersecurity tools. While not limited to such applications, embodiments of the present disclosure may be better understood in light of the aforementioned context.

To overcome the challenges described above, aspects of the present disclosure utilize a novel scoring system that can effectively measure the performance of Security Information and Event Management (SIEM) and/or Endpoint Detection and Response (EDR) rules. In doing so, aspects of the present disclosure can provide organizations insights on how to optimize their detection capabilities within their Security Operation Centers (SOCs). For example, aspects of the present disclosure can enable SOCs to strategically select which SIEM and/or EDR tools to implement to within an enterprise environment to increase threat detection coverage.

To provide an accurate assessment of SIEM or EDR rules, aspects of the present disclosure utilize all or some of eleven features such as, for example: MITRE® Tactics, Techniques, and Procedures (TTP) coverage, rule coverage, true positive rate, false positive rate, rule status, rule performance, duplicate rules, logic contradiction, rule changes, alert frequency, and rules with missing dependencies. These features are described in more detail below.

To characterize some or all of the aforementioned eleven features, aspects of the present disclosure can generate a cybersecurity result set by applying synthetic test data to a cybersecurity tool under test. Furthermore, aspects of the present disclosure can extract rules form the cybersecurity tool under test. Using the cybersecurity result set and the extracted rules, aspects of the present disclosure can generate some or all of the aforementioned eleven features.

Advantageously, aspects of the present disclosure provide comprehensive evaluation of cybersecurity tools by generating performance characteristics from both a cybersecurity result set (generated by applying synthetic test data to a cybersecurity tool) and extracted rules of the cybersecurity tool. The comprehensive evaluation provided by aspects of the present disclosure can enable clients to identify cybersecurity tools with relatively higher performance. Furthermore, the comprehensive evaluation provided by aspects of the present disclosure can direct enterprises in how to strategically utilize multiple cybersecurity tools, where relatively higher performance of one cybersecurity tool in some areas can augment relatively lower performance of another cybersecurity tool in those same areas (and vice versa).

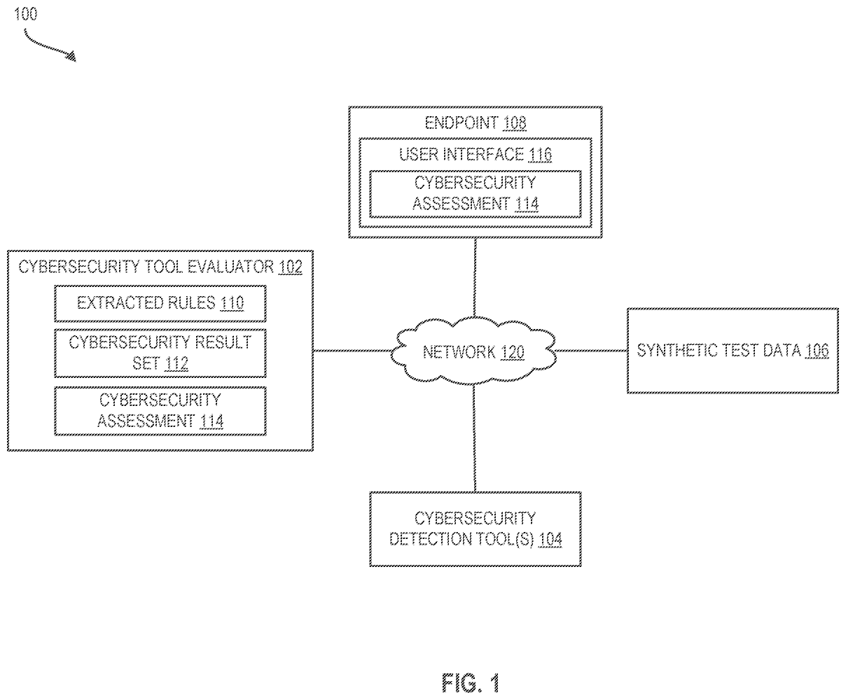

Referring now to the figures, FIG. 1 illustrates a block diagram of an example computational environment 100 implementing a cybersecurity tool evaluator 102, in accordance with some embodiments of the present disclosure. Cybersecurity tool evaluator 102 can be communicatively coupled to one or more cybersecurity detection tools 104, synthetic test data 106, and endpoint 108 via one or more networks 120.

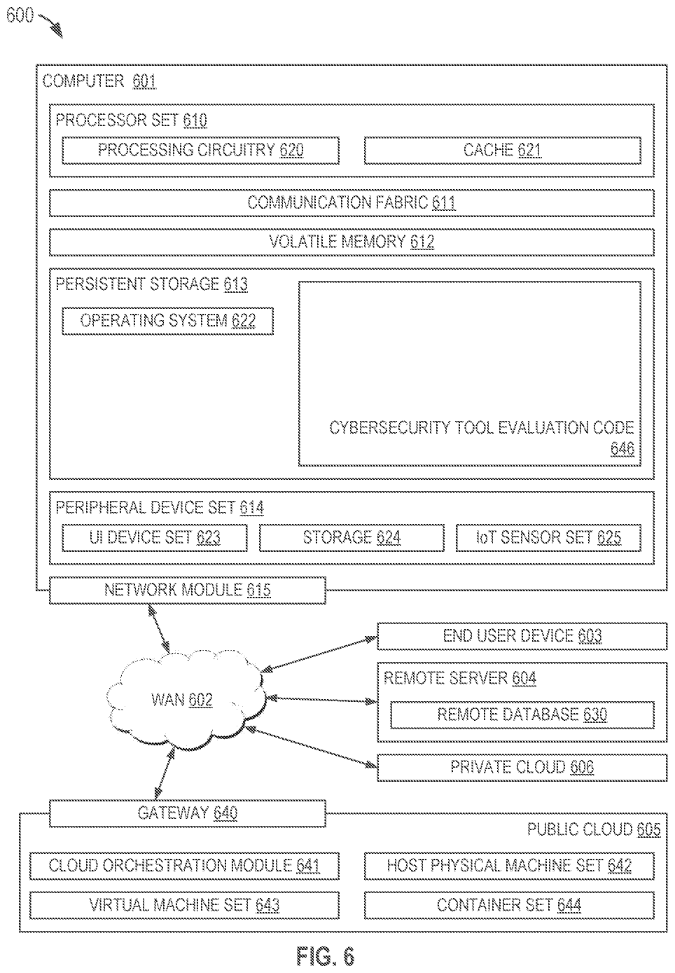

The cybersecurity tool evaluator 102, cybersecurity detection tools 104, and/or endpoint 108 can be a combination of hardware (e.g., processing resources, storage resources, and/or networking resources) and/or software. The cybersecurity tool evaluator 102, cybersecurity detection tools 104, and/or endpoint 108 can be implemented on a set of client-owned physical computing resources. Alternatively, or in addition, the cybersecurity tool evaluator 102, cybersecurity detection tools 104, and/or endpoint 108 can be implemented on virtualized computing resources vended to the client from a cloud provider (not shown). In some embodiments, the cybersecurity tool evaluator 102, cybersecurity detection tools 104, and/or endpoint 108 can be a computer (e.g., computer 601 of FIG. 6) implementing code (e.g., cybersecurity tool evaluation code 646 of FIG. 6).

The network 120 can be a local area network (LAN), a wide area network (WAN), an intranet, the Internet, or any other network 120 or group of networks 120 capable of continuously, semi-continuously, or intermittently connecting (directly or indirectly) the aforementioned components together.

Cybersecurity detection tool 104 can be a cybersecurity tool undergoing evaluation by aspects of the present disclosure. For example, the cybersecurity detection tool 104 can be an Endpoint Detection and Response (EDR) tool, an Intrusion Detection System (IDS), an Intrusion Prevention System (IPS), a Security Information and Event Management (SIEM) system, and/or any other cybersecurity tools now known or later developed.

The cybersecurity tool evaluator 102 can retrieve extracted rules 110 from the cybersecurity detection tool 104 such as, for example, by evaluating code associated with the cybersecurity detection tool 104. Evaluating the code can include static analysis (e.g., code at rest) and/or dynamic analysis (e.g., executed code). In some embodiments, evaluating the source code includes detecting and extract rules from generated control flow graphs, tree structures, and/or other representations of the code.

Furthermore, the cybersecurity tool evaluator 102 can apply the synthetic test data 106 to the cybersecurity detection tool 104. The synthetic test data 106 can be representative of production environment data (e.g., logs, network traffic, commands, etc.). Furthermore, when applied to the cybersecurity detection tool 104, the synthetic test data 106 can generate a cybersecurity result set 112 indicating how the cybersecurity detection tool 104 evaluated the synthetic test data 106. Advantageously, the synthetic test data 106 can capture both commonplace and benign behavior as well as edge-case, malicious, and/or otherwise abnormal behavior. Collectively, the cybersecurity result set 112 and the extracted rules 110 can provide a comprehensive view of the performance of the cybersecurity detection tool 104.

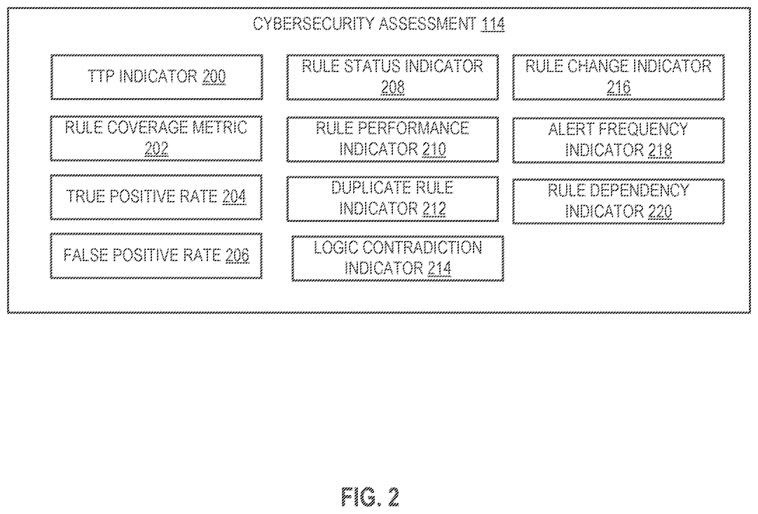

The cybersecurity tool evaluator 102 can utilize the extracted rules 110 and the cybersecurity result set 112 to generate a cybersecurity assessment 114 characterizing the performance of the cybersecurity detection tool 104. The cybersecurity assessment 114 is discussed in more detail hereinafter with respect to FIG. 2. The cybersecurity tool evaluator 102 can subsequently transmit the cybersecurity assessment 114 to the endpoint 108. The endpoint 108 can display the cybersecurity assessment 114 on a user interface 116 associated with the endpoint 108. In some embodiments, the endpoint 108 can be associated with an entity owning the cybersecurity detection tool 104, implementing the cybersecurity detection tool 104, or considering implementing the cybersecurity detection tool 104.

FIG. 1 is illustrative and more, fewer, and/or different components than the components shown in FIG. 1 can exist in other embodiments. Further, multiple components of FIG. 1 can be combined together, and/or individual components of FIG. 1 can be separated and distributed, in accordance with various embodiments of the present disclosure.

FIG. 2 illustrates a block diagram of an example cybersecurity assessment 114, in accordance with some embodiments of the present disclosure. The cybersecurity assessment 114 includes a TTP indicator 200, a rule coverage metric 202, a true positive rate 204, a false positive rate 206, a rule status indicator 208, a rule performance indicator 210, a duplicate rule indicator 212, a logic contradiction indicator 214, a rule change indicator 216, an alert frequency indicator 218, and a rule dependency indicator 220.

Regarding TTP indicator 200, it indicates whether the detection is based on some known Indicator of Compromise (IOC) or based on the Tactics, Techniques, and Procedures (TTP) that are used by the threat actors to compromise a system. Accordingly, the TTP indicator 200 represents MITRE® TTP coverage (e.g., whether detected cybersecurity events are based on an IOC or TTP).

Regarding rule coverage metric 202, regardless of how effective individual rules are, their detection is limited to the data sources or endpoints that are being monitored. For example, an effective SIEM rule to monitor suspicious activities on LINUX® servers can only be effective on the LINUX® servers that are logging in the SIEM solution and may not cover all LINUX® servers that are running inside the organization. Even though this feature is quite important to measure the effectiveness of detection capabilities, it is often overlooked in the security operation centers. Aspects of the present disclosure define the rule coverage metric 202 as the ratio of assets that are being monitored by a rule to the total number of assets from the same group that are listed in the asset database. For example, if 12 WINDOWS® servers are monitored by a SIEM rule, but there are 100 WINDOWS® servers listed in the asset database, the rule coverage is 12%.

Regarding true positive rate 204, aspects of the present disclosure consider any alert that is triaged by the T1 analysts and escalated to T2 analysts as a true positive. However, other methods of characterizing true positives exist and fall within the spirit and scope of the present disclosure.

Regarding false positive rate 206, aspects of the present disclosure consider any alert that is triaged and closed by the T1 analysts as a false positive. Since the false positive rate has a negative impact on the rule score, aspects of the present disclosure can use the negative value of false positive rate as the score. Additionally, other methods of characterizing false positives exist and fall within the spirit and scope of the present disclosure.

Regarding rule status indicator 208, this feature reflects on the status of the rule and the configured responses. A highest tier of scores are reserved for enabled rules that are configured to generate security alerts will have the highest scores. In a tier of scores lower than the aforementioned tier are rules that are not enabled but they are configured to have another action other than generating alerts (e.g. sending email, forward event, run a script, etc.). Any number of tiers with distinct scores can be utilized.

Regarding rule performance indicator 210, rules with a counter over a time period are more complicated and require more processing resources. When a rule uses a condition that has a counter over time method, such as X events over Y time period, it starts tracking the count based on defined properties. Those properties then create a unique key in memory for tracking, such as each username and IP address pair. Each unique username and IP address pair can create a separate tracked rule object in the rule correlation engine memory space. These tracked rule objects can be referred to as partial matches. Once the number of partial matches is matched within the counter during the specified time period, the rule is implemented. Rules that do not have the counter requirement have a relatively higher score (e.g., 10), and the rules with more than a threshold number (e.g., 100,000) of partial matches have a relatively lower score (e.g., 0).

Regarding duplicate rule indicator 212, aspects of the present disclosure can measure the similarity of rules by leveraging Natural Language Processing (NLP) techniques. Having similar rules can be an indication of inefficiency in the rule engine as each rule consumes resources to implement.

Regarding logic contradiction indicator 214, this feature examines the logic of the rule to find contradictory conditions. If no contradiction is identified, it will have a relatively higher score (e.g., 1). Otherwise, if one or more contradictions are identified, it will have a relatively lower score (e.g., 0).

Regarding rule change indicator 216, rules that are maintained and modified regularly are usually more reliable and effective. To measure this feature, aspects of the present disclosure set the score to a predetermined number (e.g., 10) if the rule is at least modified once in the past predetermined time period (e.g., 30 days). For every additional predetermined time period (e.g., each additional 30 days), aspects of the present disclosure can decrease the score by a predetermined amount (e.g., 1). Accordingly, and as an example, a rule that is not modified once in the past 300 days can have the score of 0.

Regarding alert frequency indicator 218, it relates to the frequency of the alerts received from each of the detection rules. Furthermore, for rules that do not trigger frequently, the alert frequency indicator 218 can include an indication to review the logic of those rules that do not trigger frequently. Rules that do not generate even one single alert for months (or years) may not have the correct logic to detect those specific threats.

Regarding rules dependency indicator 220 (e.g., rules with missing dependencies), rules are usually dependent on other components such as global parameters, log sources, events, and so on. A lack of these dependencies can result in the failure of detecting threats. Accordingly, information in the rule dependency indicator 220 can be used to notify security engineers about missing dependencies.

FIG. 2 is illustrative and more, fewer, or different indicators and/or metrics than the indicators and/or metrics shown in FIG. 2 can exist in other embodiments. Further, multiple indicators/metrics of FIG. 2 can be combined together, and/or individual indicators/metrics of FIG. 2 can be separated and distributed, in accordance with various embodiments of the present disclosure. Furthermore, although the indicators and/or metrics are described above with variable scores with higher scores reflecting positive performance and lower (or negative) scores reflecting negative performance, any number of other scoring paradigms are also possible, such as binary scores, normalized scores, letter grades, and the like. Finally, in other embodiments, higher scores can reflect negative performance and lower (or negative) scores can reflect positive performance.

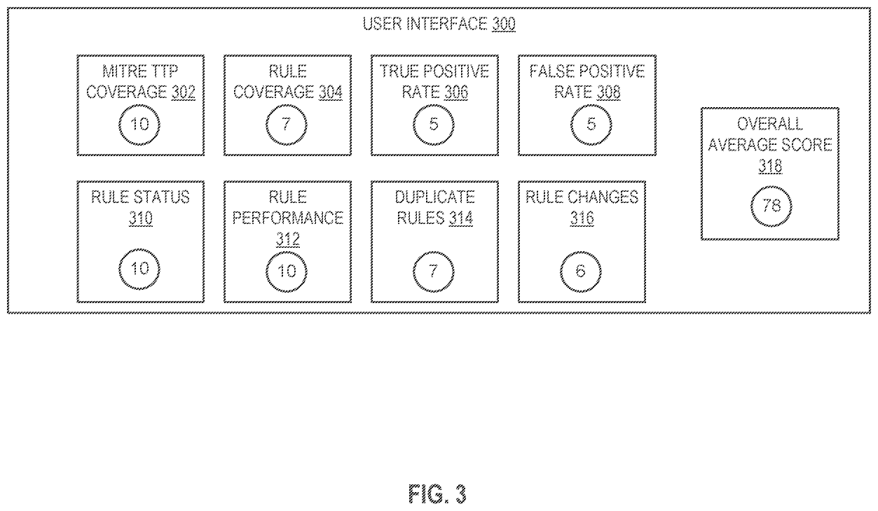

FIG. 3 illustrates a diagram of an example output of the cybersecurity tool evaluator, in accordance with some embodiments of the present disclosure. As shown in FIG. 3, the example output can be presented on a user interface 300, such as a user interface of an endpoint, terminal, desktop, laptop, tablet, smartphone, or another computational system capable of providing information to a user via a user interface. In some embodiments, user interface 300 is consistent with user interface 116 of FIG. 1. The user interface 300 displays scores (e.g., a score out of a total possible score of 10, where relatively higher scores exhibit better cybersecurity performance and relatively lower scores reflect worse cybersecurity performance) related to MITRE® TTP coverage 302, rule coverage 304, true positive rate 306, false positive rate 308, rule status 310, rule performance 312, duplicate rules 314, and rule changes 316. The user interface 300 further displays an overall average score 318 (e.g., a total average score out of a possible score of 100, where relatively higher scores reflect better cybersecurity performance and relatively lower scores reflect worse cybersecurity performance).

In some embodiments, the MITRE® TTP coverage 302 is based, at least in part, on TTP indicator 200 of FIG. 2. In some embodiments, the rule coverage 304 is based, at least in part, on rule coverage metric 202 of FIG. 2. In some embodiments, true positive rate 306 is based, at least in part, on true positive rate 204 of FIG. 2. In some embodiments, false positive rate 308 is based, at least in part, on false positive rate 206 of FIG. 2. In some embodiments, rule status 310 is based, at least in part, on rule status indicator 208 of FIG. 2. In some embodiments, rule performance 312 is based, at least in part, on rule performance indicator 210 of FIG. 2. In some embodiments, duplicate rules 314 is based, at least in part, on duplicate rule indicator 212 of FIG. 2. In some embodiments, rule changes 316 is based, at least in part, on rule change indicator 216 of FIG. 2. In some embodiments, the overall average score 318 is based, at least in part, on one or more of the TTP indicator 200, rule coverage metric 202, true positive rate 204, false positive rate 206, rule status indicator 208, rule performance indicator 210, duplicate rule indicator 212, logic contradiction indicator 214, rule change indicator 216, alert frequency indicator 218, and/or rule dependency indicator 220 of FIG. 2.

The overall average score 318 can be based on some or all of the eight subscores illustrated in FIG. 3, optionally including additional information not otherwise shown in FIG. 3. In other words, the overall average score 318 can account for additional information such as information illustrated in FIG. 2 with respect to the cybersecurity assessment 114. Furthermore, the overall average score 318 can apply various weightings to any of the underlying information utilized to generate the overall average score 318. In this way, different subscores can have associated weightings to reflect the relative informational value and/or predictive power of respective underlying subscores.

As will be appreciated by one skilled in the art, the user interface 300 is merely exemplary, and other user interfaces illustrating more or fewer subscores, intermediary scores, and/or overall scores are possible in other embodiments. Furthermore, the illustrated ranges of various subscores and/or overall scores are purely exemplary and other ranges can be used in other embodiments. As one example, all scores can be normalized to a value between 0 and 1, illustrated as a percentage, or correlated to a letter grade. Furthermore, although the scores are illustrated in circles, other indicators can likewise be used. For example, colors, graphics (e.g., graphs, charts, etc.), emojis, emoticons, symbols, and/or other features can be utilized, alone or in combination, to convey information related to any of the scores.

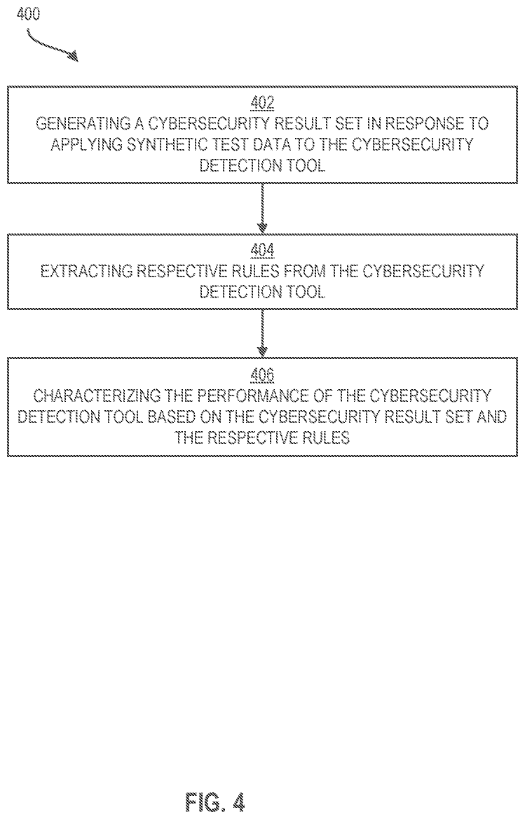

FIG. 4 illustrates a flowchart of an example method 400 for automated assessment of cybersecurity tools, in accordance with some embodiments of the present disclosure. In some embodiments, the method 400 can be implemented by a computer, a processor, or another configuration of hardware and/or software. In some embodiments, the method 400 is implemented by one or more components of FIG. 1 (e.g., cybersecurity tool evaluator 102 of FIG. 1) and/or FIG. 6 (e.g., computer 601 of FIG. 6).

Operation 402 includes generating a cybersecurity result set in response to applying synthetic test data to the cybersecurity detection tool. For example, operation 402 can include testing cybersecurity detection tool 104 using synthetic test data 106 in order to generate cybersecurity result set 112 as shown in FIG. 1.

Operation 404 includes extracting respective rules from the cybersecurity detection tool. For example, operation 404 can include generating extracted rules 110 from cybersecurity detection tool 104 as shown in FIG. 1.

Operation 406 includes characterizing the performance of the cybersecurity detection tool based on the cybersecurity result set and the respective rules. In some embodiments, operation 406 includes generating cybersecurity assessment 114 and displaying the cybersecurity assessment 114 on a user interface 116 of an endpoint 108, as shown in FIG. 1. In some embodiments, the cybersecurity assessment 114 includes information as shown in FIG. 2. In some embodiments, the cybersecurity assessment is displayed on a user interface in a manner consistent with FIG. 3.

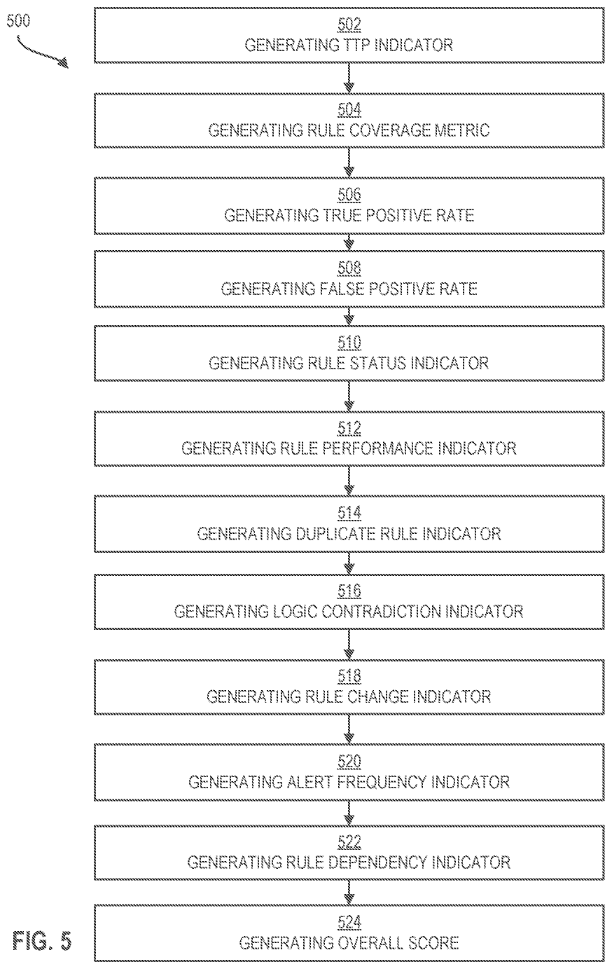

FIG. 5 illustrates a flowchart of an example method 500 for characterizing the performance of a cybersecurity detection tool, in accordance with some embodiments of the present disclosure. In some embodiments, the method 500 can be implemented by a computer, a processor, or another configuration of hardware and/or software. In some embodiments, the method 500 is implemented by one or more components of FIG. 1 (e.g., cybersecurity tool evaluator 102 of FIG. 1) and/or FIG. 6 (e.g., computer 601 of FIG. 6). In some embodiments, the method 500 is a sub-method of operation 406 of FIG. 4.

Operation 502 includes generating a TTP indicator. In some embodiments, operation 502 generates the TTP indicator 200 of FIG. 2. The TTP indicator can reflect the degree to which security events identified by the cybersecurity detection tool are based on the TTP that are used by the threat actors to compromise a system or another mechanism (e.g., IOCs). Advantageously, the TTP indicator provides useful context for how various rules of the extracted rules identify security events.

Operation 504 includes generating a rule coverage metric. In some embodiments, operation 504 generates the rule coverage metric 202 of FIG. 2. The rule coverage metric can be the ratio of assets that are being monitored by a rule to the total number of assets from the same group that are listed in the asset database. Advantageously, the rule coverage metric characterizes how comprehensively various rules of the extracted rules are applied to all components of an enterprise.

Operation 506 includes generating a true positive rate. In some embodiments, operation 506 generates the true positive rate 204 of FIG. 2. In some embodiments, the true positive rate indicates a number, percentage, and/or ratio of security events identified by the cybersecurity detection tool that are, in fact, security events. Advantageously, the true positive rate characterizes accuracy of respective rules of the extracted rules.

Operation 508 includes generating a false positive rate. In some embodiments, operation 508 generates the false positive rate 206 of FIG. 2. In some embodiments, the false positive rate indicates a number, percentage, and/or ratio of security events identified by the cybersecurity detection tool that are not, in fact, security events. Advantageously, the false positive rate characterizes accuracy of respective rules of the extracted rules.

Operation 510 includes generating a rule status indicator. In some embodiments, operation 510 generates the rule status indicator 208 of FIG. 2. The rule status indicator can be based on whether or not various rules are enables and whether or not various rules are configured to generate security alerts. Enabled rules can generate a relatively higher score than disabled rules. Additionally, rules configured to generate security alerts can generate a relatively higher score than rules that are not configured to generate security alerts. Advantageously, the rule status indicator characterizes a usefulness of respective rules of the extracted rules based on whether or not the rules are enabled and/or whether or not the rules are configured to generate security events.

Operation 512 includes generating a rule performance indicator. In some embodiments, operation 512 generates the rule performance indicator 210 of FIG. 2. The rule performance indicator can be based on whether or not rules are implemented based on a time-features and/or counter features (e.g., a number of occurrences of an event per time period generates a security event). Rules that do not have the counter requirement can have a relatively higher score (e.g., 10), and the rules with more than a threshold number (e.g., 100,000) of matches or partial matches required to trigger a security event per time period can have a relatively lower score (e.g., 0). Advantageously, the rule performance indicator reflects a time-to-detection for various rules of the extracted rules to detect a security event.

Operation 514 includes generating a duplicate rule indicator. In some embodiments, operation 514 generates the duplicate rule indicator 212 of FIG. 2. The duplicate rule indicator can use NLP to identify similar rules. Fewer similar rules can be associated with a relatively higher score (e.g., indicating an efficient use of rules) while more similar rules can be associated with a relatively lower score (e.g., indicating an inefficient use of rules). Advantageously, the duplicate rule indicator infers resource efficiency in implementing the cybersecurity detection tool based on degrees of similarity between multiple rules in the extracted rules.

Operation 516 includes generating a logic contradiction indicator. In some embodiments, operation 516 generates the logic contradiction indicator 214 of FIG. 2. The logic contradiction indicator can be based on whether or not logic contradiction(s) exist in a set of extracted rules. Rules that do not include any logic contradictions can have a relatively higher score than rules that do include at least one logic contradiction. Advantageously, the logic contradiction indicator identifies broken or otherwise less useful rules in the extracted rules.

Operation 518 includes generating a rule change indicator. In some embodiments, operation 518 generates the rule change indicator 216 of FIG. 2. Rules that are changed relatively more frequently suggest up-to-date rules and are therefore associated with a relatively higher score. Rules that are changed relatively less frequently suggest potentially expired, antiquated, or otherwise less accurate rules and can be associated with a relatively lower score. Advantageously, the rule change indicator characterizes a freshness of respective rules in the extracted rules.

Operation 520 includes generating an alert frequency indicator. In some embodiments, operation 520 generates the alert frequency indicator 218 of FIG. 2. The alert frequency indicator can be based on how frequently alerts are generated for respective rules in the extracted rules. Alerts that are generated above a frequency threshold (or within a frequency range) can be associated with a relatively higher score, whereas alerts that are generated below a the frequency threshold (and/or above an upper frequency threshold) can be associated with relatively lower scores as these alerts may be too infrequent to be effective (e.g., for alerts below a lower frequency threshold) and/or too frequent to be effective (e.g., for alerts exceeding an upper frequency threshold). Advantageously, the alert frequency indicator characterizes rule effectiveness based on the frequency of alerts generated by each rule, where rules that alert too infrequently (or too frequently) are characterized as less effective than rules that alert within a frequency range.

Operation 522 includes generating a rule dependency indicator. In some embodiments, operation 522 generates the rule dependency indicator 220 of FIG. 2. The rule dependency indicator can generate a relatively higher score for dependencies above a threshold number of dependencies and a relatively lower score for dependencies below the threshold number of dependencies for respective rules in the extracted rules. Advantageously, the rule dependency indicator can characterize rule effectiveness based on how intertwined the rule is with various system properties through dependencies.

Operation 524 includes generating an overall score. In some embodiments, operation 524 generates the overall average score 318 as shown in FIG. 3. The overall score can be a weighted combination of some or all of the aforementioned indicators and/or metrics generated in operation 502 through operation 522.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 6 illustrates a block diagram of an example computing environment, in accordance with some embodiments of the present disclosure. Computing environment 600 contains an example of an environment for the execution of at least some of the computer code involved in performing the inventive methods, such as cybersecurity tool evaluation code 646. In addition to cybersecurity tool evaluation code 646, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and cybersecurity tool evaluation code 646, as identified above), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

Computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

Processor set 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in cybersecurity tool evaluation code 646 in persistent storage 613.

Communication fabric 611 is the signal conduction paths that allow the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

Persistent storage 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface type operating systems that employ a kernel. The code included in cybersecurity tool evaluation code 646 typically includes at least some of the computer code involved in performing the inventive methods.

Peripheral device set 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

Network module 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

Remote server 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

Public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or subset of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the process software (e.g., any software configured to perform any portion of the methods described previously and/or implement any of the functionalities described previously) can be deployed by manually loading it directly in the client, server, and proxy computers via loading a storage medium such as a CD, DVD, etc., the process software can also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Embodiments of the present invention can also be delivered as part of a service engagement with a client corporation, nonprofit organization, government entity, internal organizational structure, or the like. These embodiments can include configuring a computer system to perform, and deploying software, hardware, and web services that implement, some or all of the methods described herein. These embodiments can also include analyzing the client's operations, creating recommendations responsive to the analysis, building systems that implement subsets of the recommendations, integrating the systems into existing processes and infrastructure, metering use of the systems, allocating expenses to users of the systems, and billing, invoicing (e.g., generating an invoice), or otherwise receiving payment for use of the systems.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding of the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Any advantages discussed in the present disclosure are example advantages, and embodiments of the present disclosure can exist that realize all, some, or none of any of the discussed advantages while remaining within the spirit and scope of the present disclosure.

A non-limiting list of examples are provided hereinafter to demonstrate some aspects of the present disclosure. Example 1 is a computer-implemented method. The method includes generating a cybersecurity result set in response to applying synthetic test data to the cybersecurity detection tool; extracting respective rules from the cybersecurity detection tool; and characterizing the performance of the cybersecurity detection tool based on the cybersecurity result set and the respective rules.

Example 2 include the features of Example 1. In this example, the performance includes: an indication whether the cybersecurity detection tool identifies threats based on known Indicators of Compromise (IOCs) or Tactics, Techniques, and Procedures (TTP).

Example 3 includes the features of any one of Examples 1 to 2. In this example, the performance includes: a rule coverage metric based on a ratio of assets being monitored by respective rules to a total number of similar assets.

Example 4 includes the features of any one of Examples 1 to 3. In this example, the performance includes: a true positive rate indicating accurately identified cybersecurity events by respective rules.

Example 5 includes the features of any one of Examples 1 to 4. In this example, the performance includes: a false positive rate indicating inaccurately identified cybersecurity events by respective rules.

Example 6 includes the features of any one of Examples 1 to 5. In this example, the performance includes: a rule status indicator based on a type of response implemented by respective rules.

Example 7 includes the features of any one of Examples 1 to 6. In this example, the performance includes: a rule performance indicator based on a threshold number of incidents per time period for respective rules.

Example 8 includes the features of any one of Examples 1 to 7. In this example, the performance includes: a duplicate rule indicator that indicates whether respective rules are duplicative using Natural Language Processing (NLP).

Example 9 includes the features of any one of Examples 1 to 8. In this example, the performance includes: a logic contradiction indicator indicating whether respective rules contain logic contradictions.

Example 10 includes the features of any one of Examples 1 to 9. In this example, the performance includes: a rule change indicator indicating a rate at which respective rules are modified.

Example 11 includes the features of any one of Examples 1 to 10. In this example, the performance includes: an alert frequency of respective rules.

Example 12 includes the features of any one of Examples 1 to 11. In this example, the performance includes: an indicator of dependencies associated with respective rules.

Example 13 includes the features of any one of Examples 1 to 12. In this example, the cybersecurity detection tool is an Endpoint Detection and Response (EDR) tool.

Example 14 includes the features of any one of examples 1 to 12. In this example, the cybersecurity detection tool is a Security Information and Event Management (SIEM) tool.

Example 15 includes the features of any one of Examples 1 to 14. In this example, the characterizing the performance of the cybersecurity detection tool further comprises: presenting, on a user interface, an overall average score, a MITRE® TTP coverage score, a rule coverage score, a true positive rate score, a false positive rate score, a role status score, a rule performance score, a duplicate rules score, and a rule changes score.

Example 16 includes the features of any one of Examples 1 to 15. In this example, the method is performed by a cybersecurity tool evaluator code. Optionally, the method further comprises: metering usage of the cybersecurity tool evaluator code; and generating an invoice based on metering the usage of the cybersecurity tool evaluator code.

Example 17 is a system. The system includes one or more computer readable storage media storing program instructions; and one or more processors which, in response to executing the program instructions, are configured to perform a method according any one of Examples 1 to 16, including or excluding optional features.

Example 18 is a computer program product. The computer program product includes one or more computer readable storage media, and program instructions collectively stored on the one or more computer readable storage media, the program instructions comprising instructions configured to cause one or more processors to perform a method according to any one of Examples 1 to 16, including or excluding optional features.

What is claimed is:

1. A method for characterizing performance of a cybersecurity detection tool, the method comprising:
generating a cybersecurity result set in response to applying synthetic test data to the cybersecurity detection tool;
extracting respective rules from the cybersecurity detection tool; and
characterizing the performance of the cybersecurity detection tool based on the cybersecurity result set and the respective rules.

2. The method of claim 1, wherein the performance includes:
an indication whether the cybersecurity detection tool identifies threats based on known Indicators of Compromise (IOCs) or Tactics, Techniques, and Procedures (TTP).

3. The method of claim 1, wherein the performance includes:
a rule coverage metric based on a ratio of assets being monitored by the respective rules to a total number of similar assets.

4. The method of claim 1, wherein the performance includes:
a true positive rate indicating accurately identified cybersecurity events by the respective rules.

5. The method of claim 1, wherein the performance includes:
a false positive rate indicating inaccurately identified cybersecurity events by the respective rules.

6. The method of claim 1, wherein the performance includes:
A rule status indicator based on a type of response implemented by the respective rules.

7. The method of claim 1, wherein the performance includes:
a rule performance indicator based on a threshold number of incidents per time period for the respective rules.

8. The method of claim 1, wherein the performance includes:
a duplicate rule indicator that indicates whether the respective rules are duplicative using Natural Language Processing (NLP).

9. The method of claim 1, wherein the performance includes:
a logic contradiction indicator indicating whether the respective rules contain logic contradictions.

10. The method of claim 1, wherein the performance includes:
a rule change indicator indicating a rate at which the respective rules are modified.

11. The method of claim 1, wherein the performance includes:
an alert frequency of the respective rules.

12. The method of claim 1, wherein the performance includes:
an indicator of dependencies associated with the respective rules.

13. The method of claim 1, wherein the cybersecurity detection tool is an Endpoint Detection and Response (EDR) tool.

14. The method of claim 1, wherein the cybersecurity detection tool is a Security Information and Event Management (SIEM) tool.

15. The method of claim 1, wherein the characterizing the performance of the cybersecurity detection tool further comprises:
presenting, on a user interface, an overall average score, a MITRE® TTP coverage score, a rule coverage score, a true positive rate score, a false positive rate score, a role status score, a rule performance score, a duplicate rules score, and a rule changes score.

16. The method of claim 1, wherein the method is performed by a cybersecurity tool evaluator code, and wherein the method further comprises:
metering usage of the cybersecurity tool evaluator code; and
generating an invoice based on metering the usage of the cybersecurity tool evaluator code.

17. A system comprising:
one or more computer readable storage media storing program instructions; and
one or more processors which, in response to executing the program instructions, are configured to perform a method comprising:
generating a cybersecurity result set in response to applying synthetic test data to a cybersecurity detection tool;
extracting respective rules from the cybersecurity detection tool; and
characterizing performance of the cybersecurity detection tool based on the cybersecurity result set and the respective rules.

18. The system of claim 17, wherein the program instructions for characterizing the performance of the cybersecurity detection tool comprises further instructions to perform the method further comprising:
presenting, on a user interface, an overall average score, a MITRE® TTP coverage score, a rule coverage score, a true positive rate score, a false positive rate score, a role status score, a rule performance score, a duplicate rules score, and a rule changes score.

19. A computer program product comprising one or more computer readable storage media, and program instructions collectively stored on the one or more computer readable storage media, the program instructions comprising instructions configured to cause one or more processors to perform a method comprising:
generating a cybersecurity result set in response to applying synthetic test data to a cybersecurity detection tool;
extracting respective rules from the cybersecurity detection tool; and
characterizing performance of the cybersecurity detection tool based on the cybersecurity result set and the respective rules.

20. The computer program product of claim 19, wherein the program instructions for characterizing the performance of the cybersecurity detection tool comprises further instructions to perform the method further comprising:
presenting, on a user interface, an overall average score, a MITRE® TTP coverage score, a rule coverage score, a true positive rate score, a false positive rate score, a role status score, a rule performance score, a duplicate rules score, and a rule changes score.
